(19) United States
(12) Patent Application Publication
(10) Pub. No.: US 2026/0342890 A1
(43) Pub. Date: Oct. 29, 2026

(54) PROTOCOL CONVERSION APPARATUS, METHOD, PROGRAM, AND SYSTEM

(71) Applicant: Yokogawa Electric Corporation, Tokyo (JP)

(72) Inventors: Soichiro KATSUSHIMA, Tokyo (JP); Ikuhiko ISHIKAWA, Tokyo (JP)

(21) Appl. No.: 19/124,248

(22) PCT Filed: Feb. 19, 2024
(86) PCT No.: PCT/JP2024/005715

§ 371 Date: Apr. 24, 2025

(30) Foreign Application Priority Data
Mar. 8, 2023 (JP) 2023-035982

(51) Int. Cl. H04L 69/08; H04L 41/16

(52) U.S. Cl. CPC H04L 69/08; H04L 41/16

(57) ABSTRACT

To provide a protocol conversion apparatus including a first communication part which receives a first parameter from first communication equipment communicating by using a first communication protocol, a storage part which stores therein a second communication protocol dictionary including a plurality of second parameters of a second communication protocol, a specifying part which specifies, among the plurality of second parameters, a corresponding second parameter which corresponds to the first parameter, based on a table in which the first parameter is made to correspond to a second parameter of the plurality of second parameters, and a second communication part which transmits, to second communication equipment by using the second communication protocol, second data in accordance with the first data concerning the first parameter made to correspond to the corresponding second parameter.

### TECHNICAL FIELD

The present invention relates to a protocol conversion apparatus, a method, a program, and a system. The contents of the following patent application(s) are incorporated herein by reference:
NO. 2023-035982 filed in JP on Mar. 8, 2023

### BACKGROUND

Patent document 1 describes a system of collecting data from an automation plant having field equipment (ABSTRACT). Patent document 2 describes a conversion apparatus which converts event-based data communication into cyclic data communication (ABSTRACT, claim 1).

### Prior Art Document

### Patent Document

Patent Document 1: Specification of U.S. Patent Application Publication No. 2021/271228

Patent Document 2: International Publication No. WO 2020/078716

### GENERAL DISCLOSURE

A first aspect of the present invention provides a protocol conversion apparatus including a first communication part which receives first data concerning a first parameter from first communication equipment communicating by using a first communication protocol, a storage part which stores therein a second communication protocol dictionary including a plurality of second parameters of a second communication protocol, a specifying part which specifies, among the plurality of second parameters, a corresponding second parameter which corresponds to the first parameter, based on a table in which the first parameter is made to correspond to a second parameter of the plurality of second parameters, and a second communication part which transmits, to second communication equipment by using the second communication protocol, second data in accordance with the first data concerning the first parameter made to correspond to the corresponding second parameter.

In the above-described protocol conversion apparatus, the storage part may store therein a plurality of the second communication protocol dictionaries for a first communication protocol dictionary made to correspond to a type of the first communication equipment, the protocol conversion apparatus may further include a dictionary selecting part which selects, among the plurality of second communication protocol dictionaries, a second communication protocol dictionary which corresponds to the first communication protocol dictionary of the first communication equipment communicating by the first communication part, and the specifying part may specify the corresponding second parameter based on the table in which the second parameter included in the second communication protocol dictionary selected by the dictionary selecting part is made to correspond to the first parameter. The dictionary selecting part may have a dictionary table indicating a corresponding relationship between an identifier of each type of the first communication equipment or an identifier of each piece of the first communication equipment and a second communication protocol dictionary, and may specify the second communication protocol dictionary which corresponds to the first communication equipment from the dictionary table.

In any of the above-described protocol conversion apparatuses, when the second parameter cannot be specified based on the table, the specifying part may specify, in response to input of designation of one of a first parameter in the first communication protocol or a second parameter in the second communication protocol, the corresponding second parameter or a corresponding first parameter among the plurality of second parameters or a plurality of the first parameters by using a model for specifying another of the first parameter in the first communication protocol or the second parameter in the second communication protocol which corresponds to the first parameter or the second parameter designated in the designation. The specifying part may update the table so as to indicate a corresponding relationship between the first parameter and the corresponding second parameter specified with the model.

The above-described protocol conversion apparatus may further include a learning processing part which updates the model in accordance with user designation for the corresponding second parameter specified by the specifying part.

The above-described protocol conversion apparatus may further include a registration part which registers a flag in a corresponding relationship with the second data of the corresponding second parameter specified by the specifying part by using the model.

In the above-described protocol conversion apparatus, the registration part may register the second data in accordance with the first data in a corresponding relationship with the corresponding second parameter in the second communication protocol dictionary.

Any of the above-described protocol conversion apparatuses may further include a converting part which converts a value of the first data into the second data by at least one of multiplication by a coefficient in accordance with a relationship between the first parameter and the corresponding second parameter, or by calculation with a function in accordance with the relationship.

In any of the above-described protocol conversion apparatuses, the second communication protocol may be a protocol for performing communication at a higher speed than the first communication protocol. The first communication protocol may be a BRAIN communication protocol. The second communication protocol may be a HART (registered trademark) protocol.

In any of the above-described protocol conversion apparatuses, the second communication protocol dictionary may include, as at least one of the plurality of second parameters, a parameter concerning at least one of an order code, an order receiving condition of a manufacturer, traceability information, or information on working states relating to the first communication equipment.

In any of the above-described protocol conversion apparatuses, the storage part may store therein a first communication protocol dictionary including a plurality of first parameters of the first communication protocol, the second communication part may receive, from the second communication equipment, second data concerning a second parameter included in the second communication protocol dictionary, the specifying part may specify a corresponding first parameter which corresponds to the second parameter based on the table, and the first communication part may transmit, to the first communication equipment, first data in accordance with the second data concerning the second parameter made to correspond to the corresponding first parameter.

The above-described protocol conversion apparatus may include an updating part which updates at least one parameter in at least one of the first communication protocol dictionary or the second communication protocol dictionary.

The updating part may update at least one parameter in at least one of the first communication protocol dictionary or the second communication protocol dictionary stored on the storage part together with at least one parameter in a first communication protocol dictionary stored on the first communication equipment.

Any of the above-described protocol conversion apparatuses may further include a counting part which counts, concerning a parameter in at least one of the first communication protocol dictionary or the second communication protocol dictionary stored on the storage part, at least one of a number of times of specification by the specifying part or a number of times of update by the updating part, where the updating part may update at least one parameter in at least one of the first communication protocol dictionary or the second communication protocol dictionary stored on the storage part by deleting, from the corresponding first or second communication protocol dictionary, the parameter of which at least one of the counted number of times of specification or number of times of update is less than a threshold value.

A second aspect of the present invention provides a method including receiving first data concerning a first parameter from first communication equipment communicating by using a first communication protocol, storing a second communication protocol dictionary including a plurality of second parameters of a second communication protocol, specifying, based on a table in which the first parameter is made to correspond to a second parameter of the plurality of second parameters, a corresponding second parameter which corresponds to the first parameter among the plurality of second parameters, and transmitting, to second communication equipment by using the second communication protocol, second data in accordance with the first data concerning the first parameter made to correspond to the corresponding second parameter.

A third aspect of the present invention provides a program for causing a computer to function as a first communication part which receives first data concerning a first parameter from first communication equipment communicating by using a first communication protocol, a storage part which stores therein a second communication protocol dictionary including a plurality of second parameters of a second communication protocol, a specifying part which specifies, among the plurality of second parameters, a corresponding second parameter which corresponds to the first parameter, based on a table in which the first parameter is made to correspond to a second parameter of the plurality of second parameters, and a second communication part which transmits, to second communication equipment by using the second communication protocol, second data in accordance with the first data concerning the first parameter made to correspond to the corresponding second parameter.

A fourth aspect of the present invention provides a system including first communication equipment, any of the above-described protocol conversion apparatuses communicating with the first communication equipment by using a first communication protocol, and second communication equipment communicating with the protocol conversion apparatus by using a second communication protocol.

The summary clause does not necessarily describe all necessary features of the embodiments of the present invention. The present invention may also be a sub-combination of the features described above.

### BRIEF DESCRIPTION OF THE DRAWINGS

FIG. 1 is an example of a block diagram showing a system of the present embodiment.

FIG. 2 illustrates an example of a first communication protocol dictionary.

FIG. 3 is a flow diagram showing a protocol converting operation in a protocol conversion apparatus 30.

FIG. 4 is an illustration for describing a parameter specifying operation in the protocol conversion apparatus 30.

FIG. 5 is an illustration for describing a parameter specifying model.

FIG. 6 illustrates an example of a computer 2200 in which a plurality of aspects of the present invention may be entirely or partially embodied.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are essential to the solution of the invention.

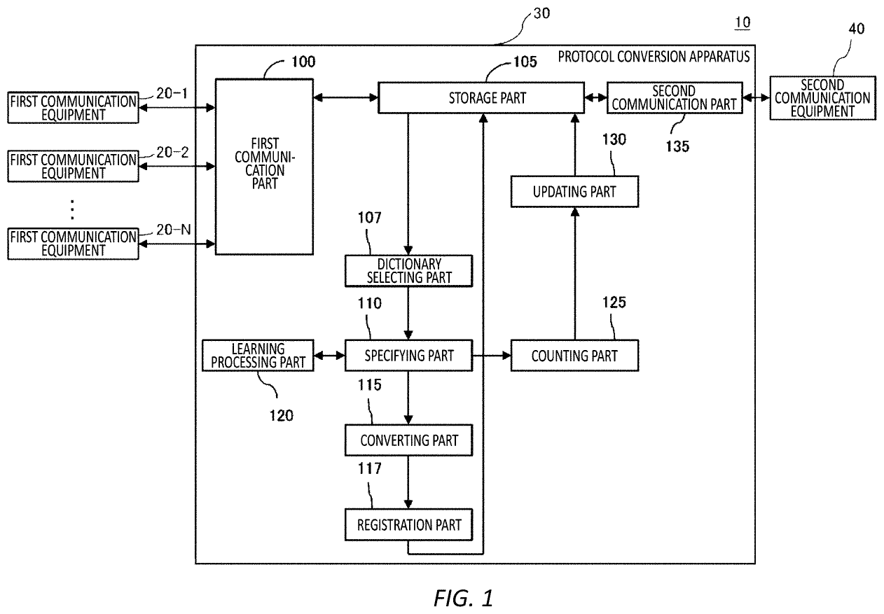

FIG. 1 is an example of a block diagram showing a system 10 of the present embodiment. Note that, these blocks are functional blocks that are each functionally divided, and may not be necessarily required to be matched with actual apparatus configurations. That is, in the present drawing, an apparatus indicated by one block may not be necessarily required to be configured by one apparatus. In addition, in the present drawing, apparatuses indicated by separate blocks may not be necessarily required to be configured by separate apparatuses. The same applies to subsequent block diagrams.

The system 10 collects data from equipment such as a sensor installed in a facility such as a plant. Examples of the plant may include a plant for managing and controlling wells such as a gas field and an oil field and surroundings thereof, a plant for managing and controlling hydroelectric, thermo electric and nuclear power generations and the like, a plant for managing and controlling environmental power generation such as solar power and wind power, a plant for managing and controlling water and sewerage, a dam, and the like, etc., in addition to chemical and bio industrial plants and the like.

The system 10 includes at least one piece of first communication equipment 20, a protocol conversion apparatus 30, and second communication equipment 40.

The at least one piece of first communication equipment 20-1 to N (N is 2 or more) is each communicatively connected to the protocol conversion apparatus 30. Note that, hereinafter, the first communication equipment 20-1 to N may be collectively described as the first communication equipment 20. The first communication equipment 20 may be field equipment. The field equipment is, for example, sensor equipment such as a pressure gauge, a flowmeter, or a temperature sensor, valve equipment such as a flow rate control valve or an opening and closing valve, actuator equipment such as a fan or a motor, imaging equipment such as a camera or a video which captures an image of a situation or an object in a plant, acoustic equipment such as a microphone or a speaker which collects abnormal noise or the like in a plant or issues warning sound or the like, position detection equipment which outputs position information of each piece of equipment, or other pieces of equipment.

The first communication equipment 20 transmits or receives data such as a measurement value or a control value to/from the protocol conversion apparatus 30 by using a first communication protocol. The first communication protocol may be a communication protocol stipulated by HART (registered trademark), BRAIN, PROFINET, Profibus PA, EtherNet (registered trademark)/IP (registered trademark), OPC UA (registered trademark), Foundation Fieldbus (registered trademark), ISA 100. 11a, or the like. The first communication protocol may be a communication protocol of a relatively low speed (several kbps to several tens of kbps).

The second communication equipment 40 is communicatively connected to the protocol conversion apparatus 30. The second communication equipment 40 may be a computer such as a personal computer (PC), a tablet computer, a smartphone, a workstation, a server computer, or a general-purpose computer, or may be a computer system to which a plurality of computers is connected, or may be a distributed control system (DCS), an apparatus which automatically controls a machine (PLC: Programmable Logic Controller), or a system which collects information and performs monitoring, while also performing control, by utilizing a network (SCADA: Supervisory Control And Data Acquisition). Such a computer system is also a computer in a broad sense. In addition, the second communication equipment 40 may be implemented by one or more virtual computer environments executable in a computer.

The second communication equipment 40 communicates with the protocol conversion apparatus 30 by using a second communication protocol, and collects data such as a measurement value or a set value of the first communication equipment 20, while also setting data such as a control value for the first communication equipment 20, via the protocol conversion apparatus 30. The second communication protocol may be a communication protocol stipulated by HART (registered trademark), BRAIN, PROFINET, Profibus PA, EtherNet (registered trademark)/IP, OPC UA Foundation Fieldbus (registered trademark), ISA 100. 11a, or the like. The second communication protocol is a communication protocol different from the first communication protocol, and may be a communication protocol for performing communication at a higher speed than the first communication protocol.

The protocol conversion apparatus 30 may be a computer such as a PC, a tablet computer, a smartphone, a workstation, a server computer, a measuring instrument or a recording instrument into which a computer system is incorporated, edge computing, or a general-purpose computer. The protocol conversion apparatus 30 converts different communication protocols between the first communication equipment 20 and the second communication equipment 40, and performs transmission and reception of data. The protocol conversion apparatus 30 has a first communication part 100, a storage part 105, a dictionary selecting part 107, a specifying part 110, a converting part 115, a registration part 117, a learning processing part 120, a counting part 125, an updating part 130, and a second communication part 135.

The first communication part 100 is connected to the storage part 105, and receives first data concerning a first parameter from the first communication equipment 20 which communicates by using the first communication protocol. The first communication part 100 stores the received first data on the storage part 105. The first parameter may include at least one of a name, a definition, a type (for example, a measurement value, a control value, a set value, an upper limit value, or a lower limit value), an attribute, a meaning, or a unit of the first data stipulated by the first communication protocol.

The storage part 105 is connected to each configuration of the protocol conversion apparatus 30, and it stores therein a first communication protocol dictionary and a second communication protocol dictionary. The storage part 105 may store therein a plurality of second communication protocol dictionaries with respect to the first communication protocol dictionary made to correspond to a type of the first communication equipment 20.

The first communication protocol dictionary is a data dictionary in which each of a plurality of the first parameters of the first communication protocol is made to correspond to data concerning each first parameter (values and the like of the first parameters). The second communication protocol dictionary is a data dictionary in which each of a plurality of second parameters of the second communication protocol, which is stipulated by at least one of a standard format of IEC 61987 CDD (Common Data Dictionary) or ecl@ss, is made to correspond to second data concerning each second parameter (values and the like of the second parameters). The second parameter may include at least one of a name, a definition, a type (for example, a measurement value, a control value, a set value, an upper limit value, or a lower limit value), an attribute, a meaning, or a unit of the second data stipulated by the second communication protocol. The first communication protocol dictionary and the second communication protocol dictionary may further include at least one parameter that may not be stipulated in the standard format of IEC 61987 CDD (Common Data Dictionary) or ecl@ss, for example, a parameter unique to a manufacturer. The second communication protocol dictionary may further include, as at least one of the plurality of second parameters, a parameter concerning at least one of an order code, an order receiving condition of a manufacturer, traceability information, harmful substance information, or information on working states relating to the first communication equipment 20. The plurality of second parameters of the second communication protocol may be based on different stipulations from those of the plurality of first parameters of the first communication protocol.

The dictionary selecting part 107 is connected to the storage part 105 and the specifying part 110, and selects the second communication protocol dictionary corresponding to a type of the first communication equipment 20 among the plurality of second communication protocol dictionaries stored on the storage part 105. The dictionary selecting part 107 may select the second communication protocol dictionary corresponding to the first communication equipment 20 or corresponding to an instruction of the second communication equipment 40.

The specifying part 110 is connected to the learning processing part 120, the counting part 125, and the converting part 115. The specifying part 110 specifies, among the plurality of second parameters in the second communication protocol dictionary, a corresponding second parameter which corresponds to a first parameter based on a table in which the first parameters are made to correspond to the second parameters (hereinafter, also referred to as a parameter table). The specifying part 110 may specify the corresponding second parameter based on the parameter table in which the second parameters included in the second communication protocol dictionary selected by the dictionary selecting part 107 are made to correspond to the first parameters. If the second parameter cannot be specified based on the parameter table, the specifying part 110 may specify, in response to input of designation of one of a first parameter in the first communication protocol or a second parameter in the second communication protocol, a corresponding second parameter among the plurality of second parameters by using a model (hereinafter, also referred to as a parameter specifying model) for specifying another of the first parameter in the first communication protocol or the second parameter in the second communication protocol corresponding to the designated parameter.

The converting part 115 is connected to the registration part 117. The converting part 115 converts the first data into the second data by converting a value of the first data into a value in accordance with the corresponding second parameter specified by the specifying part 110. For example, the converting part 115 performs conversion in accordance with a relationship between the first parameter and the second parameter.

The registration part 117 is connected to the storage part 105. The registration part 117 registers the second data in accordance with the first data in a corresponding relationship with the corresponding second parameter in the second communication protocol dictionary. The registration part 117 may store the second data on the storage part 105 in a corresponding relationship with the corresponding second parameter in the second communication protocol dictionary.

The learning processing part 120 is connected to the specifying part 110. The learning processing part 120 updates the parameter specifying model in accordance with the user designation for the corresponding second parameter specified by the specifying part 110. The learning processing part 120 may learn and process the parameter specifying model used by the specifying part 110, and update the parameter specifying model. The learning processing part 120 may update the parameter specifying model by, for example, supervised learning.

The counting part 125 is connected to the updating part 130. The counting part 125 counts at least one of a number of times of specification by the specifying part 110 or a number of times of update by the updating part 130, concerning parameters in at least one of the first communication protocol dictionary or the second communication protocol dictionary stored on the storage part 105. The counting part 125 may record not only a simple number of times of specification or number of times of update, but also at least one of dates/times of a history of specification or update, content of specification or update, or the like.

The updating part 130 is connected to the storage part 105. The updating part 130 updates at least one parameter in at least one of the first communication protocol dictionary or the second communication protocol dictionary stored on the storage part 105. The updating part 130 may update at least one parameter in at least one of the first communication protocol dictionary or the second communication protocol dictionary in accordance with a count in the counting part 125. The updating part 130 may update at least one parameter in at least one of the first communication protocol dictionary or the second communication protocol dictionary in accordance with update data received from the first communication equipment 20 or the second communication equipment 40. The updating part 130 may update at least one parameter in at least one of the first communication protocol dictionary or the second communication protocol dictionary stored on the first communication equipment 20 or the second communication equipment 40 so as to synchronize at least one of the first communication protocol dictionary or the second communication protocol dictionary stored on the storage part 105 with at least one of the first communication protocol dictionary or the second communication protocol dictionary stored on the first communication equipment 20 or the second communication equipment 40.

The second communication part 135 is connected to the storage part 105 and the second communication equipment 40. The second communication part 135 transmits, to the second communication equipment 40 by using the second communication protocol, the second data in accordance with the first data concerning the first parameter made to correspond to the corresponding second parameter. The second communication part 135 may read and transmit the second data stored on the storage part 105.

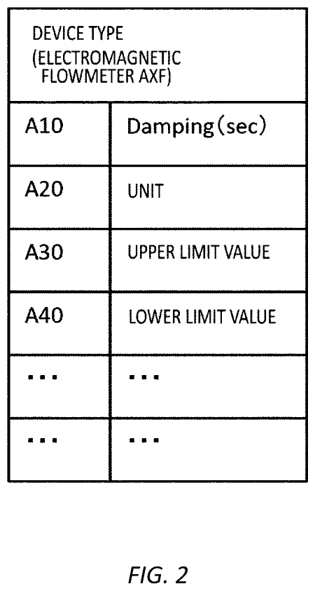

FIG. 2 illustrates an example of the first communication protocol dictionary. The first communication protocol dictionary is stipulated concerning each piece of first communication equipment 20, and it may be a table in which codes indicating first parameters are made to correspond to each first parameter. The first communication protocol dictionary in FIG. 2 is stipulated concerning the first communication equipment 20 including an electromagnetic flowmeter, and it stipulates that a code A10 represents a set value Damping (the unit is sec) of the electromagnetic flowmeter, a code A20 represents a unit of a measurement value of the electromagnetic flowmeter, a code A30 represents an upper limit value of the measurement value of the electromagnetic flowmeter, a code A40 represents a lower limit value of the measurement value of the electromagnetic flowmeter, etc. A of the codes in FIG. 2 may be an identifier of each type of the first communication equipment 20 or an identifier of each piece of first communication equipment 20, and each of 10, 20, . . . of the codes may be an identifier assigned to the first parameters. The first communication protocol dictionary may further include first data of the first parameters in a corresponding relationship with each code. Note that the second communication protocol dictionary in the present embodiment may also have a similar configuration as that of the first communication protocol dictionary.

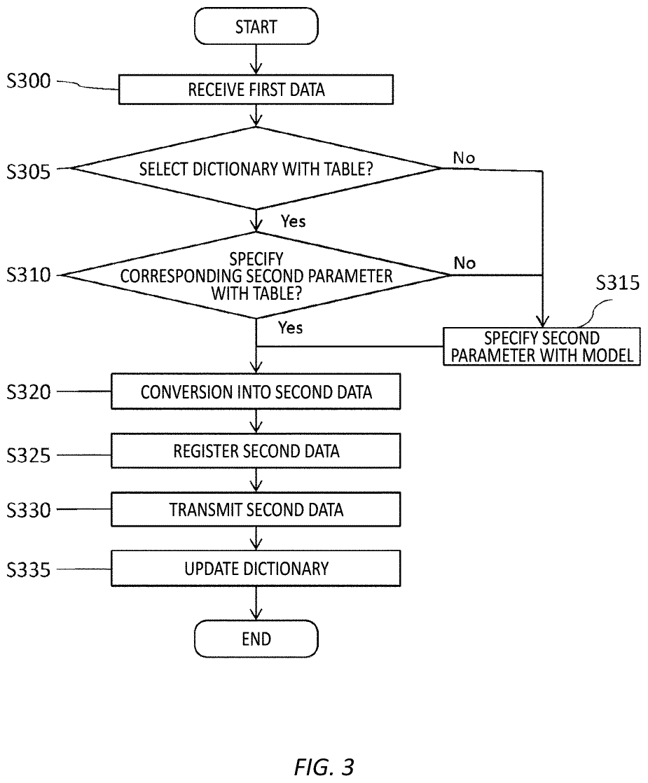

FIG. 3 is a flow diagram showing a protocol converting operation in the protocol conversion apparatus 30. In step S300, the first communication part 100 of the protocol conversion apparatus 30 receives first data concerning a first parameter from the first communication equipment 20. The first communication part 100 may receive the first data together with a code indicating the first communication equipment 20 and the first parameter. The first communication part 100 may receive the first data from the first communication equipment 20 by using a BRAIN communication protocol as an example. The protocol conversion apparatus 30 may receive the first data concerning the first parameter from the first communication equipment 20 periodically or in response to a change in the first data of the first parameter in the first communication equipment 20. In addition, the protocol conversion apparatus 30 may transmit a command requesting read-in of the first parameter to the first communication equipment 20, and may receive the first data made to correspond to an identifier of the command from the first communication equipment 20. The protocol conversion apparatus 30 may store the received first data on a corresponding first communication protocol dictionary in the storage part 105, or may store the received first data on the storage part 105 in a corresponding relationship with the first parameter.

In step S305, the dictionary selecting part 107 specifies and selects, in the storage part 105, one dictionary from a plurality of second communication protocol dictionaries corresponding to an identifier of the first communication equipment 20 which transmitted the first data. The dictionary selecting part 107 may select a second communication protocol dictionary corresponding to an identifier of each type of the first communication equipment 20 or an identifier of each piece of the first communication equipment 20 which transmitted the first data. The dictionary selecting part 107 may have a dictionary table showing a corresponding relationship between an identifier of each type of the first communication equipment 20 or an identifier of each piece of the first communication equipment 20 and the second communication protocol dictionaries, and from the dictionary table, the dictionary selecting part 107 may specify the second communication protocol dictionary corresponding to the first communication equipment 20. If the dictionary selecting part 107 has selected the second communication protocol dictionary corresponding to the first communication equipment 20 (if Yes), the protocol conversion apparatus 30 proceeds the processing to step S310. If the dictionary selecting part 107 cannot specify the second communication protocol dictionary corresponding to the first communication equipment 20 in the storage part 105 (if No), the protocol conversion apparatus 30 proceeds the processing to step S315. For example, the dictionary selecting part 107 cannot specify the corresponding second communication protocol dictionary when the second communication protocol dictionary corresponding to the identifier of the first communication equipment 20 is not stipulated in the dictionary table. Note that the dictionary table may be input by a user, and it may be previously created by the specifying part 110 by adding a corresponding relationship between first communication equipment and a second communication protocol dictionary specified with the parameter specifying model.

In step S310, the specifying part 110 specifies a corresponding second parameter which corresponds to the first parameter among a plurality of second parameters, in the second communication protocol dictionary selected by the dictionary selecting part 107. The specifying part 110 may have a parameter table showing a corresponding relationship between a first parameter and a second parameter, and may specify the corresponding second parameter which corresponds to the first parameter using the parameter table. If the specifying part 110 has specified the corresponding second parameter (if Yes), the protocol conversion apparatus 30 proceeds the processing to step S320. If the specifying part 110 cannot specify the corresponding second parameter in the selected second communication protocol dictionary (if No), the protocol conversion apparatus 30 proceeds the processing to step S315. For example, the specifying part 110 cannot specify the corresponding second parameter when the corresponding second parameter is not stipulated in the parameter table. Note that the parameter table may be input by the user, and it may be previously created by the specifying part 110 by adding a corresponding relationship between a first parameter and a second parameter specified with the parameter specifying model.

In step S315, the specifying part 110 specifies the corresponding second parameter which corresponds to the first parameter by using the parameter specifying model. The specifying part 110 may input designation of the first parameter to the model, and may specify a parameter that is output of the parameter specifying model as the corresponding second parameter. In this case, the specifying part 110 may update the dictionary table and the parameter table so as to show the corresponding relationship between the first parameter and the corresponding second parameter specified with the parameter specifying model, and may store the updated dictionary table and the updated parameter table on the specifying part 110.

In step S320, the converting part 115 converts a value of the first data in accordance with the corresponding second parameter specified by the specifying part 110. The converting part 115 may convert the value of the first data into second data by at least one of multiplication by a coefficient in accordance with the relationship between the first parameter and the corresponding second parameter, or by calculation with a function in accordance with the corresponding second parameter.

For example, if the unit of a measurement value that is the first parameter is cm (centimeter) and the unit of the corresponding second parameter is m (meter), and the units are different from each other, the converting part 115 can make the first data adapt to the corresponding second parameter by multiplying the value of the first data by a coefficient (1/100). In addition, if a set value (as an example, Damping) that is the first parameter represents a value (as an example, 100 sec) and the corresponding second parameter represents a ratio (as an example, a ratio % between the upper limit 200 and the lower limit 0 of the set value), the converting part 115 can make the first data adapt to the corresponding second parameter by performing conversion into a ratio using a function (as an example, 100×100 sec/(200 sec-0 sec)=50%)).

The coefficient and the function used in the converting part 115 may be input by the user, and may be stored on the parameter table in association with the corresponding relationship between the first parameter and the corresponding second parameter.

In step S325, the registration part 117 registers the second data in a corresponding relationship with the corresponding second parameter. The registration part 117 may store the second data on the second communication protocol dictionary in a corresponding relationship with the corresponding second parameter, or may store a position (an address or the like) of the second data in the storage part 105 on the second communication protocol dictionary. When receiving a measurement value as the first data from the first communication equipment 20, the registration part 117 may register a time stamp indicating a measurement time or a reception time of the first data in a corresponding relationship with the second data.

The registration part 117 may register a flag in a corresponding relationship with the second data of the corresponding second parameter specified by the specifying part 110 by using the parameter specifying model. For example, the registration part 117 registers the second data of the corresponding second parameter specified by using the parameter specifying model in step S315 in a corresponding relationship with a flag value 1, and may register the second data of the corresponding second parameter specified by using the parameter table in S310 in a corresponding relationship with a flag value 0. The user can determine, for data registered with the flag, with which of the parameter specifying model or the parameter table the correspondence of the parameters is shown, and can create data (for example, supervised data) for learning of the parameter specifying model.

In step S330, the second communication part 135 transmits the second data concerning the corresponding second parameter by using the second communication protocol. The second communication part 135 may transmit the second data to the second communication equipment 40 by using a HART (registered trademark) protocol as an example. The second communication part 135 may transmit the second data in the storage part 105 to the second communication equipment 40 in response to reception of a command requesting the corresponding second parameter from the second communication equipment 40, or periodically. For example, once receiving a code indicating the corresponding second parameter together with the command, the second communication part 135 may specify a second parameter corresponding to the code in the second communication protocol dictionary, and may read the second data made to correspond to the second parameter from the storage part 105 for transmission. Once receiving an identifier of the first communication equipment 20 together with a read-in command instead of the corresponding second parameter, the second communication part 135 may transmit, to the second communication equipment 40, the second data of the corresponding second parameter which corresponds to the first data received from the first communication equipment 20.

The second communication part 135 may transmit, to the second communication equipment 40, a flag indicating whether the parameter specifying model is used for parameter specification together with the second data. The second communication part 135 may transmit, to the second communication equipment 40, a corresponding time stamp together with the second data. In addition, the second communication part 135 can aim for a higher speed and load distribution of communication by transmitting a difference between the second data and data of the corresponding second parameter transmitted the last time.

The second communication part 135 may transmit the second data to the second communication equipment 40 by using a data checking function such as a Cyclic Redundancy Check (CRC). The second communication part 135 can transmit check data calculated from the second data to be transmitted using a predetermined expression together with the second data, and the second communication equipment 40 can compare a value calculated from the received second data using the same predetermined expression with the received check data to detect an error and the like of the data. In this manner, reliability of the data can be enhanced. The predetermined expression may be stipulated by the user.

In step S335, the updating part 130 updates at least one parameter in at least one of the first communication protocol dictionary or the second communication protocol dictionary in accordance with update data from the second communication equipment 40 or a count of the counting part 125. Once the second communication part 135 receives update data indicating change or deletion of a corresponding parameter together with a code of a first parameter or a second parameter from the second communication equipment 40, the updating part 130 may update the corresponding parameter in the first communication protocol dictionary or the second communication protocol dictionary stored in the storage part 105 by change or deletion. In addition, once the second communication part 135 receives update data indicating addition of a new parameter to at least one of the first communication protocol dictionary or the second communication protocol dictionary, the updating part 130 may update the first communication protocol dictionary or the second communication protocol dictionary stored in the storage part 105 by adding the new parameter.

The counting part 125 may count, for a plurality of first communication protocol dictionaries and a plurality of second communication protocol dictionaries stored on the storage part 105, a number of times of specification by the specifying part 110 (or a number of times data is registered by the registration part 117) of each parameter. Furthermore, the counting part 125 may count a number of times of updating at least one of the first communication protocol dictionary or the second communication protocol dictionary by the update data received from the second communication equipment 40. The updating part 130 may update at least one of the first communication protocol dictionary or the second communication protocol dictionary stored on the storage part 105 by deleting, from a corresponding dictionary, the parameter of which at least one of the counted number of times of specification or number of times of update within a predetermined period of time is less than a threshold value (for example, 0). The threshold value may be set by the user. The updating part 130 can delete unnecessary parameters, reduce the frequency of information transmission, and reduce a database amount (memory amount) or information amount (communication power) so that specification of a parameter becomes efficient.

When the first communication equipment 20 has the first communication protocol dictionary, and the second communication equipment 40 has at least one of the first communication protocol dictionary or the second communication protocol dictionary, the updating part 130 may update at least one parameter in at least one of the first communication protocol dictionary or the second communication protocol dictionary stored on the storage part 105 together with at least one parameter in the first communication protocol dictionary stored on at least one of the first communication equipment 20 or the second communication equipment 40. The updating part 130 may transmit, to at least one of the first communication equipment 20 or the second communication equipment 40, update data for performing the same update as the at least one of the first communication protocol dictionary or the second communication protocol dictionary in the storage part 105. For example, the second communication part 135 receives update data of at least one parameter in at least one of the first communication protocol dictionary or the second communication protocol dictionary from the second communication equipment 40, and updates at least one parameter in at least one of the first communication protocol dictionary or the second communication protocol dictionary of the storage part 105. The first communication part 100 transmits, to the first communication equipment 20, update data of at least one parameter in the first communication protocol dictionary. The first communication equipment 20 stores therein the received update data of the at least one parameter in the first communication protocol dictionary. In this manner, the updating part 130 may synchronize all dictionaries in the system 10. In this manner, it becomes possible for the entire system to follow a new management item updated in a product life cycle of the first communication equipment 20. At this time, the protocol conversion apparatus 30 may transmit the update data by using a data checking function such as a Cyclic Redundancy Check (CRC) as in the case of step S330.

Note that the protocol conversion apparatus 30 may transmit the second data to the second communication equipment 40 in response to receiving a command to readout or write-in a first parameter by using the second communication protocol from the second communication equipment 40. In this case, the second communication equipment 40 may have the first communication protocol dictionary, the second communication protocol dictionary, the dictionary table, the specifying part, the registration part, the dictionary selecting part, and the parameter table, which are the same as those of the protocol conversion apparatus 30.

For example, when reading a first parameter from the first communication equipment 20, the second communication equipment 40 may specify a second parameter corresponding to the first parameter as in the case of the protocol conversion apparatus 30. The second communication equipment 40 transmits, to the protocol conversion apparatus 30, a command requesting the first data in accordance with the second data concerning the corresponding first parameter which corresponds to the second parameter together with a code indicating the second parameter. The second parameter may be a measurement value read from the first communication equipment 20.

The dictionary selecting part 107 may select, from the dictionary table, a first communication protocol dictionary corresponding to a second communication protocol dictionary of the requested second parameter. The specifying part 110 may specify, among a plurality of first parameters in the selected first communication protocol dictionary, a corresponding first parameter which corresponds to the second parameter by using the parameter table. If the dictionary table does not stipulate the corresponding first communication protocol dictionary or if the parameter table does not stipulate the corresponding first parameter, the specifying part 110 may specify, in response to input of designation of the second parameter in the second communication protocol, a corresponding first parameter which corresponds to the second parameter by using the parameter specifying model for specifying the corresponding first parameter which corresponds to the designated second parameter.

The first communication part 100 may transmit a read request of the corresponding first parameter to the first communication equipment 20. The first communication equipment 20 can transmit, in response to the read request, a measured measurement value (the first data concerning the corresponding first parameter) to the protocol conversion apparatus 30.

The first communication part 100 receives the first data concerning the requested corresponding first parameter, and the registration part 117 registers the received first data in a corresponding first communication protocol dictionary. The converting part 115 may make the first data concerning the corresponding first parameter in the first communication protocol dictionary adapt to a second parameter by converting the first data into second data in accordance with the first data by using a conversion function or the like. The registration part 117 may register the second data in a corresponding relationship with the second parameter requested by the command in the second communication protocol dictionary. The second communication part 135 may transmit the converted second data to the second communication equipment 40. At this time, the second communication part 135 may transmit the second data together with an identifier (a transaction identifier or the like) corresponding to the command which made the read request of the second parameter.

In addition, when writing a first parameter such as a control value for controlling the first communication equipment 20 in a first communication protocol dictionary of the first communication equipment 20, the second communication equipment 40 may transmit a command to write in the first parameter. As in the case of the protocol conversion apparatus 30, the second communication equipment 40 may specify a second parameter corresponding to the first parameter, and may transmit, to the protocol conversion apparatus 30, second data concerning the second parameter and a command to request write-in together with a code indicating the second parameter. In this manner, the first communication equipment 20 can control an object to be controlled in accordance with the written control value.

In the protocol conversion apparatus 30, the specifying part 110 may specify a corresponding first parameter which corresponds to the second parameter by using at least one of the dictionary table, the parameter table, or the parameter specifying model, and the converting part 115 may convert the second data into corresponding first data so as to adapt to the corresponding first parameter. The first communication part 100 may transmit the first data to the first communication equipment 20 together with a code of the specified corresponding first parameter, and may register the first data in the first communication protocol dictionary in the first communication equipment 20. In this case, the protocol conversion apparatus 30 may register the first data and the second data in a corresponding first communication protocol dictionary and a corresponding second communication protocol dictionary in the storage part 105 for synchronization with the first communication protocol dictionary in the first communication equipment 20.

The first communication equipment 20 may transmit the registered first data to the protocol conversion apparatus 30 together with the code of the first parameter. As in the case of the read request, the protocol conversion apparatus 30 may specify a corresponding second parameter of the first parameter, and convert the first data into second data. The protocol conversion apparatus 30 may transmit a code indicating the corresponding second parameter and the second data to the second communication equipment 40. In this manner, the second communication equipment 40 can confirm whether the second data requested to be written in has been registered in the first communication protocol dictionary of the first communication equipment 20.

In addition, the protocol conversion apparatus 30 may communicate with the second communication equipment 40 in response to receiving, from the second communication equipment 40, a command requesting information (a second parameter) in the storage part 105. Once receiving, from the second communication equipment 40, a read command together with a code of at least one of an order code, an order receiving condition of a manufacturer, traceability information, harmful substance information, or information on working states relating to the first communication equipment 20, the protocol conversion apparatus 30 may transmit, to the second communication equipment 40, corresponding information in the second communication protocol dictionary in the storage part 105 together with the code.

The order code relating to the first communication equipment 20 is a code associated with a purchase system when purchasing the first communication equipment 20. The order receiving condition of a manufacturer relating to the first communication equipment 20 is at least one of a lead time, price, or part number in purchasing of the first communication equipment 20. The traceability information relating to the first communication equipment 20 is information relating to measuring precision of the first communication equipment 20. The harmful substance information relating to the first communication equipment 20 is information relating to a risk of a chemical substance that is an object to be measured by the first communication equipment 20. The information on working states relating to the first communication equipment 20 is at least one of CO₂ emissions, maintenance information, working time, or power consumption relating to working of the first communication equipment 20.

The protocol conversion apparatus 30 may acquire, from the first communication equipment 20 or the second communication equipment 40, at least one of the order code, the order receiving condition of a manufacturer, the traceability information, the harmful substance information, or the information on working states. In addition, the protocol conversion apparatus 30 may calculate the information on working states from information acquired from the first communication equipment 20. For example, the protocol conversion apparatus 30 may acquire a working time (as an example, 24 hours×300 days) of the first communication equipment 20 from the first communication equipment 20, and may calculate a value in accordance with the working time from information (as an example, power consumption 4 mW per unit time of the first communication equipment 20) stored on the second communication protocol dictionary (as an example, total power consumption=24×300 ×4).

By storing such information, the protocol conversion apparatus 30 facilitates parts selection at the time of occurrence of a malfunction, procurement of a new product, or the like, and also can facilitate planning of a maintenance timing, concerning the first communication equipment 20.

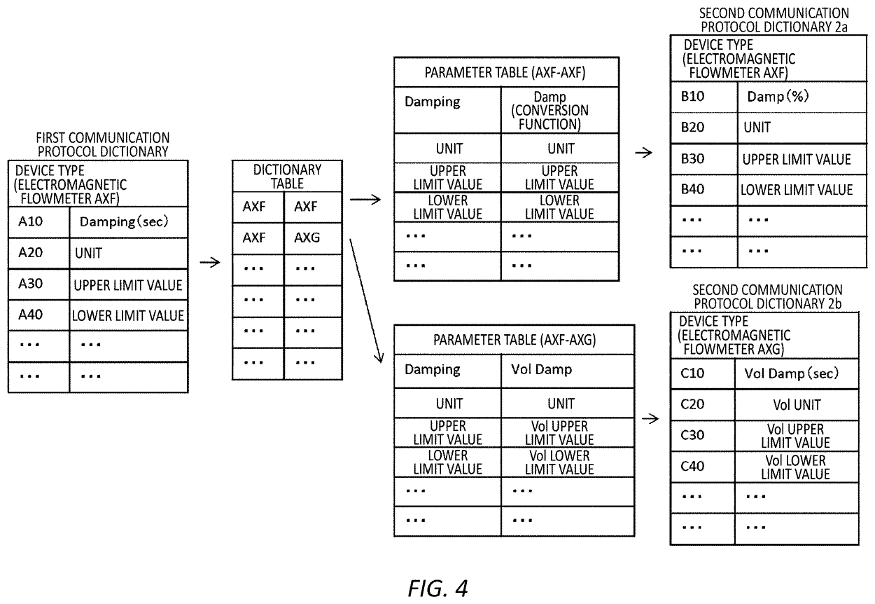

FIG. 4 is an illustration for describing a parameter specifying operation in the protocol conversion apparatus 30. In FIG. 4, the protocol conversion apparatus 30 receives data concerning one parameter in a first communication protocol dictionary, and specifies each of corresponding parameters in two second communication protocol dictionaries 2a, 2b.

Once the first communication part 100 receives data indicating a value of Damping together with the code A10 from the first communication equipment 20, the dictionary selecting part 107 refers to the dictionary table to specify equipment AXF corresponding to an identifier A of the first communication equipment 20 (AXF) and select the second communication protocol dictionary 2a used for the specified equipment. The specifying part 110 refers to a parameter table (AXF-AXF), and specifies a corresponding second parameter B10 which corresponds to the code A10 in the second communication protocol dictionary 2a. The converting part 115 converts the received value with a conversion function stored on the parameter table (AXF-AXF). The registration part 117 registers the value converted by the converting part 115 in a corresponding relationship with the second parameter B10.

In addition, once the first communication part 100 receives data indicating a value of Damping together with the code A10 from the first communication equipment 20, the dictionary selecting part 107 refers to the dictionary table to specify equipment AXG corresponding to the identifier A of the first communication equipment 20 (AXF) and select the second communication protocol dictionary 2b used for the specified equipment. The specifying part 110 refers to a parameter table (AXF-AXG), and specifies a corresponding second parameter C10 which corresponds to the code A10 in the second communication protocol dictionary 2b. Since a conversion function is not stored on the parameter table (AXF-AXG), the registration part 117 registers a value that has not been converted (the value of the data received by the first communication part 100) in a corresponding relationship with the second parameter C10.

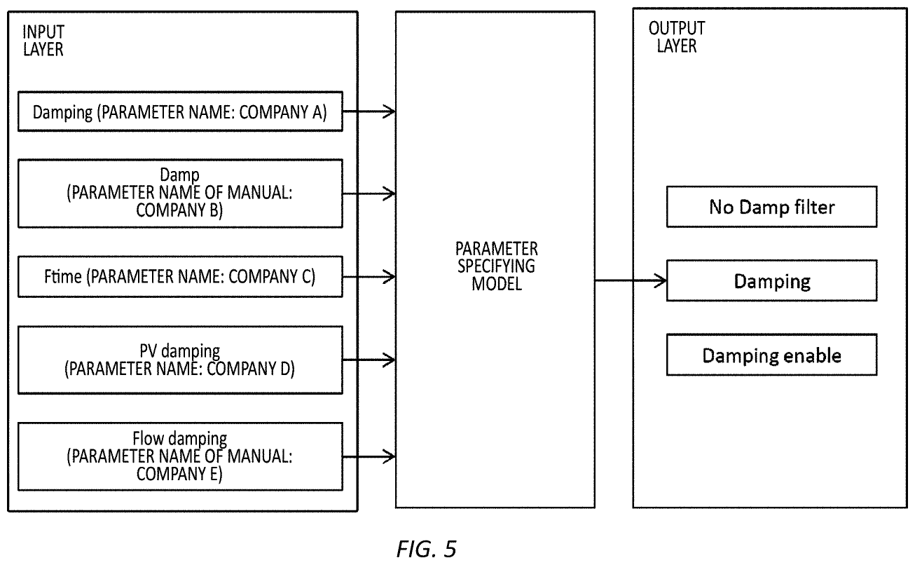

FIG. 5 is an illustration for describing the parameter specifying model. The parameter specifying model may be a machine learning model such as a neural network, a decision tree, or the like. Once designation of a first parameter is input, the parameter specifying model outputs a corresponding second parameter. As the designation of the first parameter, text data including at least one of first data received from the first communication equipment 20, content of a first communication protocol dictionary corresponding to the first parameter (a definition and the like of the first parameter), or a document of a manual concerning the first communication equipment 20 may be input to the parameter specifying model. The parameter specifying model may output, as the corresponding second parameter, a second parameter having the highest probability among a plurality of second parameters of a plurality of second communication protocol dictionaries.

In the parameter specifying model of the example in FIG. 5, in any of cases where “Damping (parameter name: company A)”, “Damp (parameter name of the manual: company B)”, “Ftime (parameter name: company C), “PV damping (parameter name: company D)”, and “Flow damping (parameter name of the manual: company E)” are input, a second parameter “Damping” of a second communication protocol dictionary is output. For example, even if the second communication protocol dictionary has other parameters relevant to Damping such as “No Damp filter” and “Damping enable”, the corresponding second parameter can be correctly specified by collecting information in an input layer. “Damping (parameter name: company A)” indicates that a parameter name called Damping and a manufacturer name of the first communication equipment 20 are input; “Damp (parameter name of the manual: company B)” indicates that a parameter name described in the manual called Damp and a manufacturer name of the first communication equipment 20 are input; “Ftime (parameter name: company C)” indicates that a parameter name called Ftime and a manufacturer name of the first communication equipment 20 are input; “PV damping (parameter name: company D)” indicates that a parameter name called PV damping and a manufacturer name of the first communication equipment 20 are input; and “Flow damping (parameter name of the manual: company E)” indicates that a parameter name called Flow damping and a manufacturer name of the first communication equipment 20 are input.

The learning processing part 120 may generate and update the parameter specifying model. The learning processing part 120 may acquire, as learning data, content of a plurality of first communication protocol dictionaries and a plurality of second communication protocol dictionaries (manufacturer names, names, definitions, and the like) in the storage part 105. The learning processing part 120 may further acquire, as the learning data, data of a handling description (text data of a document or the like) of the first communication equipment 20 which corresponds to a first communication protocol dictionary from the user, the first communication equipment 20, or the second communication equipment 40. The learning processing part 120 may acquire, as supervised data, a set of a first parameter and a second parameter having a known corresponding relationship which is previously designated by the user or the like.

The learning processing part 120 may perform character strings analysis on learning data including a first communication protocol dictionary, a second communication protocol dictionary, and a manual of the corresponding first communication equipment 20 (text data such as names or descriptions of parameters) for feature vectorization, and may learn the parameter specifying model so as to output a corresponding relationship between feature vectors.

For example, the learning processing part 120 extracts a plurality of predetermined keywords from text data which is the learning data, and obtains a feature vector, concerning each parameter. The learning processing part 120 may learn the parameter specifying model such that a matching degree between a feature vector of a first parameter and a feature vector of a corresponding second parameter having a known corresponding relationship is calculated higher, and a matching degree between a feature vector of a first parameter and a feature vector of a second parameter known as not corresponding is calculated lower. The specifying part 110 may specify a second parameter having a feature vector of which a matching degree with a feature vector calculated from input designation of a first parameter by using the parameter specifying model is a threshold value or higher or is the highest, as the corresponding second parameter. The plurality of predetermined keywords and the threshold value may be input to the learning processing part 120 by the user, or may be determined by the learning processing part 120 by learning.

The learning processing part 120 may update the parameter specifying model in response to user designation that the corresponding second parameter output by the specifying part 110 by using the parameter specifying model is incorrect. Once an operator or an equipment vendor inputs, to the learning processing part 120, user designation indicating a corrected corresponding second parameter concerning second data with a registered flag indicating that the second data is specified by using the parameter specifying model, the learning processing part 120 may perform learning processing by using supervised data in which the corrected corresponding second parameter is labeled on the input first parameter, and update the parameter specifying model. Note that, once designation of a second parameter is input, the learning processing part 120 may perform the same learning for the parameter specifying model which outputs a corresponding first parameter.

With the protocol conversion apparatus 30 of the present embodiment, it becomes possible to efficiently convert data between the first communication equipment 20 using a communication protocol of a parameter unique to equipment and the second communication equipment 40 using a latest communication protocol, by using a plurality of pieces of dictionary data based on different stipulations. In addition, even when the first communication equipment 20 or the second communication equipment 40 is newly added, corresponding relationships of parameters can be accurately specified by a learning model by using dictionary data, a manual, or the like.

Note that the protocol conversion apparatus 30 of the present embodiment may be arranged in the second communication equipment 40 such as a server. In this case, the protocol conversion apparatus 30 may register first data from the first communication equipment 20 by converting the first data into second data, as in the case of steps S300 to S325 of FIG. 3. Note that the protocol conversion apparatus 30 does not have to include the second communication part 135, and a transmission operation of second data in step S330 does not have to be executed. In addition, the protocol conversion apparatus 30 of the present embodiment may be arranged in a sensor module including the first communication equipment 20.

When a corresponding parameter is not stipulated in the dictionary table or the parameter table, the protocol conversion apparatus 30 of the present embodiment performs specification by using the parameter specifying model. However, alternatively, the protocol conversion apparatus 30 may transmit, to the second communication equipment 40, an error message indicating that a corresponding parameter is not stipulated in the dictionary table or the parameter table. In addition, the present embodiment describes an embodiment in which the protocol conversion apparatus 30 performs conversion between two communication protocols. However, the protocol conversion apparatus 30 of the present embodiment may similarly perform conversion among three or more communication protocols.

In addition, various embodiments of the present invention may be described with reference to flowcharts and block diagrams, wherein the block may serve as (1) a stage in a process in which a manipulation is performed, or (2) a section of an apparatus having a role of performing a manipulation. Certain stages and sections may be implemented by dedicated circuit, programmable circuit supplied with computer-readable instructions stored on computer-readable media, and/or processors supplied with computer-readable instructions stored on computer-readable media. Dedicated circuit may include digital and/or analog hardware circuits, and may include integrated circuits (IC) and/or discrete circuits. The programmable circuit may include a reconfigurable hardware circuit including logical AND, logical OR, logical XOR, logical NAND, logical NOR, and other logical manipulations, a memory element such as a flip-flop, a register, a field programmable gate array (FPGA) and a programmable logic array (PLA), and the like.

A computer-readable medium may include any tangible device that can store instructions to be executed by a suitable device, and as a result, the computer-readable medium having instructions stored thereon includes an article of manufacture including instructions which can be executed in order to create means for performing manipulations designated in the flowcharts or block diagrams. Examples of the computer-readable medium may include an electronic storage medium, a magnetic storage medium, an optical storage medium, an electromagnetic storage medium, a semiconductor storage medium, and the like. More specific examples of the computer-readable medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a Blu-ray (registered trademark) disk, a memory stick, an integrated circuit card, and the like.

The computer-readable instruction may include: an assembler instruction, an instruction-set-architecture (ISA) instruction; a machine instruction; a machine dependent instruction; a microcode; a firmware instruction; state-setting data; or either a source code or an object code written in any combination of one or more programming languages, including an object oriented programming language such as Smalltalk (registered trademark), JAVA (registered trademark), C++, or the like; and a conventional procedural programming language such as a “C” programming language or a similar programming language.

Computer-readable instructions may be provided to a processor of a general-purpose computer, special purpose computer, or other programmable data processing apparatuses, or to a programmable circuit, locally or via a local area network (LAN), wide area network (WAN) such as the Internet, or the like, to execute the computer-readable instructions to create means for performing manipulations designated in the flowcharts or block diagrams. Examples of the processor include a computer processor, a processing unit, a microprocessor, a digital signal processor, a controller, a microcontroller, and the like.

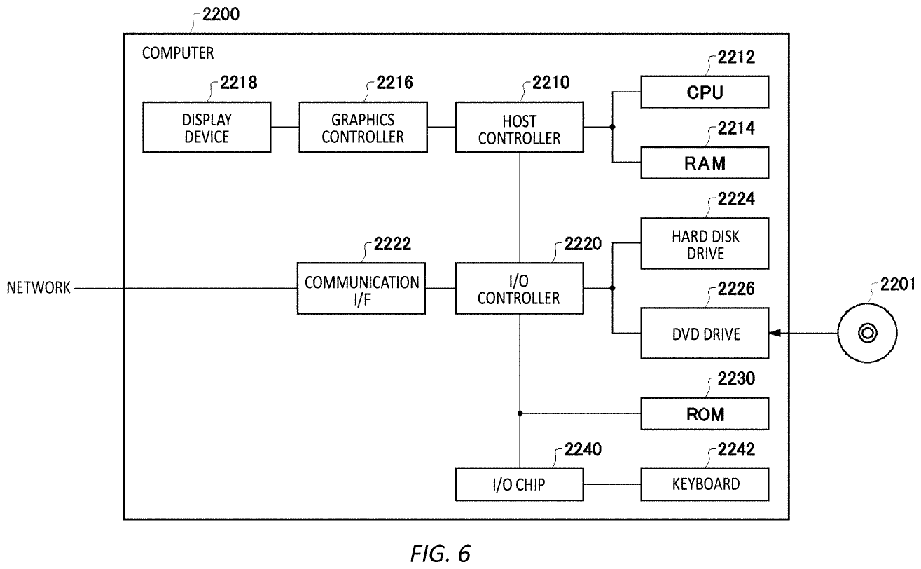

FIG. 6 illustrates an example of a computer 2200 in which the plurality of aspects of the present invention may be entirely or partially embodied. A program installed in the computer 2200 may cause the computer 2200 to function as a manipulation associated with the apparatuses according to the embodiments of the present invention or as one or more sections of the apparatuses, or may cause the manipulation or the one or more sections to be executed, and/or may cause the computer 2200 to execute a process according to the embodiments of the present invention or a stage of the process. Such programs may be executed by a CPU 2212 in order to cause the computer 2200 to perform certain manipulations associated with some or all of the blocks in the flowcharts and block diagrams described in the present specification.

The computer 2200 according to the present embodiment includes the CPU 2212, a RAM 2214, a graphics controller 2216, and a display device 2218, which are mutually connected by a host controller 2210. The computer 2200 further includes input/output units such as a communication interface 2222, a hard disk drive 2224, a DVD-ROM drive 2226, and an IC card drive, which are connected to the host controller 2210 via an input/output controller 2220. The computer also includes legacy input/output units such as a ROM 2230 and a keyboard 2242, which are connected to the input/output controller 2220 via an input/output chip 2240.

The CPU 2212 operates according to programs stored in the ROM 2230 and the RAM 2214, thereby controlling each unit. The graphics controller 2216 obtains image data generated by the CPU 2212 on a frame buffer or the like provided in the RAM 2214 or in itself, and causes the image data to be displayed on the display device 2218.

The communication interface 2222 communicates with other electronic devices via a network. The hard disk drive 2224 stores programs and data used by the CPU 2212 in the computer 2200. The DVD-ROM drive 2226 reads the programs or the data from the DVD-ROM 2201, and provides the hard disk drive 2224 with the programs or the data via the RAM 2214. The IC card drive reads the programs and the data from the IC card, and/or writes the programs and the data to the IC card.

The ROM 2230 stores therein boot programs and the like executed by the computer 2200 at the time of activation, and/or programs that depend on the hardware of the computer 2200. The input/output chip 2240 may also connect various input/output units to the input/output controller 2220 via a parallel port, a serial port, a keyboard port, a mouse port, and the like.

The program is provided by a computer-readable medium such as the DVD-ROM 2201 or the IC card. The program is read from a computer-readable medium, installed in the hard disk drive 2224, the RAM 2214, or the ROM 2230 which are also examples of the computer-readable medium, and executed by the CPU 2212. The information processing written in these programs is read by the computer 2200 and provides cooperation between the programs and the above-described various types of hardware resources. The apparatus or method may be configured by realizing manipulations or processing of information according to use of the computer 2200.

For example, in a case where communication is performed between the computer 2200 and an external device, the CPU 2212 may execute a communication program loaded in the RAM 2214 and instruct the communication interface 2222 to perform communication processing on the basis of processing written in the communication program. Under the control of the CPU 2212, the communication interface 2222 reads transmission data stored in a transmission buffer processing area provided in a recording medium such as the RAM 2214, the hard disk drive 2224, the DVD-ROM 2201, or the IC card, transmits the read transmission data to the network, or writes reception data received from the network in a reception buffer processing area or the like provided on the recording medium.

In addition, the CPU 2212 may cause the RAM 2214 to read all or a necessary part of a file or database stored in an external recording medium such as the hard disk drive 2224, the DVD-ROM drive 2226 (DVD-ROM 2201), the IC card, or the like, and may execute various types of processing on data on the RAM 2214. Next, the CPU 2212 writes back the processed data to the external recording medium.

Various types of information such as various types of programs, data, tables, and databases may be stored in a recording medium and subjected to information processing. The CPU 2212 may execute various types of processing on the data read from the RAM 2214 to write back a result to the RAM 2214, the processing being described throughout the present disclosure, designated by instruction sequences of the programs, and including various types of manipulations, information processing, condition determinations, conditional branching, unconditional branching, information searches/replacements, or the like. In addition, the CPU 2212 may search for information in a file, a database, etc., in the recording medium. For example, when a plurality of entries, each having an attribute value of a first attribute associated with an attribute value of a second attribute, are stored in the recording medium, the CPU 2212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The programs or software modules described above may be stored in a computer-readable medium on or near the computer 2200. In addition, a recording medium such as a hard disk or a RAM provided in a server system connected to a dedicated communication network or the Internet can be used as a computer-readable medium, thereby providing a program to the computer 2200 via the network.

While the present invention has been described by way of the embodiments, the technical scope of the present invention is not limited to the scope of the descriptions in the above-described embodiments. It is apparent to persons skilled in the art that various alterations or improvements can be made to the above-described embodiments. It is also apparent from the description of the claims that embodiments added with such alterations or improvements can be included in the technical scope of the present invention.

The operations, procedures, steps, and stages of each processing performed by an apparatus, system, program, and method illustrated in the claims, embodiments, or diagrams can be performed in any order as long as the order is not indicated by “prior to,” “before,” or the like and as long as the output from previous processing is not used in later processing. Even if the operation flow is described by using phrases such as “first” or “next” in the scope of the claims, specification, or diagrams, it does not necessarily mean that the process must be performed in this order.

### EXPLANATION OF REFERENCES

10: system;
20: first communication equipment;
30: protocol conversion apparatus;
40: second communication equipment;
100: first communication part;
105: storage part;
107: dictionary selecting part;
110: specifying part;
115: converting part;
117: registration part;
120: learning processing part;
125: counting part;
130: updating part;
135: second communication part;
2200: computer;
2201: DVD-ROM;
2210: host controller;
2212: CPU;
2214: RAM;
2216: graphics controller;
2218: display device;
2220: input/output controller;
2222: communication interface;
2224: hard disk drive;
2226: DVD-ROM drive;
2230: ROM;
2240: input/output chip; and
2242: keyboard.

What is claimed is:

1. A protocol conversion apparatus comprising:
a first communication part which receives first data concerning a first parameter from first communication equipment communicating by using a first communication protocol;
a storage part which stores therein a second communication protocol dictionary including a plurality of second parameters of a second communication protocol;
a specifying part which specifies, among the plurality of second parameters, a corresponding second parameter which corresponds to the first parameter, based on a table in which the first parameter is made to correspond to a second parameter of the plurality of second parameters; and
a second communication part which transmits, to second communication equipment by using the second communication protocol, second data in accordance with the first data concerning the first parameter made to correspond to the corresponding second parameter.

2. The protocol conversion apparatus according to claim 1, wherein
the storage part stores therein a plurality of second communication protocol dictionaries, each being identical to the second communication protocol dictionary, for a first communication protocol dictionary made to correspond to a type of the first communication equipment,
the protocol conversion apparatus further comprises a dictionary selecting part which selects, among the plurality of second communication protocol dictionaries, the second communication protocol dictionary which corresponds to the first communication protocol dictionary of the first communication equipment communicating by the first communication part, and
the specifying part specifies the corresponding second parameter based on the table in which the second parameter included in the second communication protocol dictionary selected by the dictionary selecting part is made to correspond to the first parameter.

3. The protocol conversion apparatus according to claim 1, wherein
when the second parameter cannot be specified based on the table, the specifying part specifies, in response to input of designation of one of a first parameter in the first communication protocol or a second parameter in the second communication protocol, the corresponding second parameter or a corresponding first parameter among the plurality of second parameters or a plurality of first parameters, each being identical to the first parameter, by using a model for specifying another of the first parameter in the first communication protocol or the second parameter in the second communication protocol which corresponds to the first parameter or the second parameter designated in the designation.

4. The protocol conversion apparatus according to claim 3, further comprising
a learning processing part which updates the model in accordance with user designation for the corresponding second parameter specified by the specifying part.

5. The protocol conversion apparatus according to claim 4, further comprising
a registration part which registers a flag in a corresponding relationship with the second data of the corresponding second parameter specified by the specifying part by using the model.

6. The protocol conversion apparatus according to claim 5, wherein
the registration part registers the second data in accordance with the first data in a corresponding relationship with the corresponding second parameter in the second communication protocol dictionary.

7. The protocol conversion apparatus according to claim 1, further comprising
a converting part which converts a value of the first data into the second data by at least one of multiplication by a coefficient in accordance with a relationship between the first parameter and the corresponding second parameter, or by calculation with a function in accordance with the relationship.

8. The protocol conversion apparatus according to claim 1, wherein
the second communication protocol is a protocol for performing communication at a higher speed than the first communication protocol.

9. The protocol conversion apparatus according to claim 1, wherein
the second communication protocol dictionary includes, as at least one of the plurality of second parameters, a parameter concerning at least one of an order code, an order receiving condition of a manufacturer, traceability information, or information on working states relating to the first communication equipment.

10. The protocol conversion apparatus according to claim 1, wherein
the storage part stores therein a first communication protocol dictionary including a plurality of first parameters of the first communication protocol,
the second communication part receives, from the second communication equipment, second data concerning a second parameter included in the second communication protocol dictionary,
the specifying part specifies a corresponding first parameter which corresponds to the second parameter based on the table, and
the first communication part transmits, to the first communication equipment, first data in accordance with the second data concerning the second parameter made to correspond to the corresponding first parameter.

11. The protocol conversion apparatus according to claim 10, comprising
an updating part which updates at least one parameter in at least one of the first communication protocol dictionary or the second communication protocol dictionary.

12. The protocol conversion apparatus according to claim 11, wherein
the updating part updates at least one parameter in at least one of the first communication protocol dictionary or the second communication protocol dictionary stored on the storage part together with at least one parameter in a first communication protocol dictionary stored on the first communication equipment.

13. The protocol conversion apparatus according to claim 11, further comprising
a counting part which counts, concerning a parameter in at least one of the first communication protocol dictionary or the second communication protocol dictionary stored on the storage part, at least one of a number of times of specification by the specifying part or a number of times of update by the updating part, wherein
the updating part updates at least one parameter in at least one of the first communication protocol dictionary or the second communication protocol dictionary stored on the storage part by deleting, from the corresponding first or second communication protocol dictionary, the parameter of which at least one of the number of times of specification or the number of times of update counted by the counting part is less than a threshold value.

14. A method comprising:
storing a second communication protocol dictionary including a plurality of second parameters of a second communication protocol;
receiving first data concerning a first parameter from first communication equipment communicating by using a first communication protocol;
specifying, based on a table in which the first parameter is made to correspond to a second parameter of the plurality of second parameters, a corresponding second parameter which corresponds to the first parameter among the plurality of second parameters; and
transmitting, to second communication equipment by using the second communication protocol, second data in accordance with the first data concerning the first parameter made to correspond to the corresponding second parameter.

15. A program for causing a computer to function as:
a first communication part which receives first data concerning a first parameter from first communication equipment communicating by using a first communication protocol;
a storage part which stores therein a second communication protocol dictionary including a plurality of second parameters of a second communication protocol;
a specifying part which specifies, among the plurality of second parameters, a corresponding second parameter which corresponds to the first parameter, based on a table in which the first parameter is made to correspond to a second parameter of the plurality of second parameters; and
a second communication part which transmits, to second communication equipment by using the second communication protocol, second data in accordance with the first data concerning the first parameter made to correspond to the corresponding second parameter.

16. A system comprising:
first communication equipment;
the protocol conversion apparatus according to any one of claims 1 to 13 which communicates with the first communication equipment by using a first communication protocol; and
second communication equipment which communicates with the protocol conversion apparatus by using a second communication protocol.
